(19) United States
(12) Patent Application Publication
(10) Pub. No.: US 2025/0139092 A1
(43) Pub. Date: May 1, 2025

(54) HISTOGRAM-AUGMENT DYNAMIC SAMPLING FOR JOIN CARDINALITY ESTIMATION

(71) Applicant: Oracle International Corporation, Redwood Shores, CA (US)

(72) Inventors: Hong Su, Redwood City, CA (US); Jiakun Li, San Mateo, CA (US); Suratna Budalakoti, Belmont, CA (US); Mohamed Ziauddin, Pleasanton, CA (US); Alan Paul Wood, San Jose, CA (US)

(21) Appl. No.: 18/384,231

(22) Filed: Oct. 26, 2023

(51) Int. Cl. G06F 16/2453; G06F 16/22

(52) U.S. Cl. CPC G06F 16/24544; G06F 16/2282

(57) ABSTRACT

A histogram-augmented dynamic sampling approach is provided for determining cardinality of a two-table join. The approach has a pre-processing phase in which data structures are created that will be used during a compilation phase for cardinality estimation. These data structures include a row histogram and a key histogram, which are created for selected columns of a first table. A cardinality estimation phase uses the data structures to estimate the cardinality of various joins at the time of query compilation. In this phase, the system executes queries that join the histograms with a second table, to perform the cardinality estimation.

### FIELD OF THE INVENTION

The present invention relates to cardinality estimation for optimizing database queries involving joins between two tables using histogram-augmented dynamic sampling.

### BACKGROUND

A schema is a collection of database objects, including tables, views, indexes, and synonyms. There are a variety of ways of arranging schema objects in the schema models designed for data warehousing. The most common data-warehouse schema model is a star schema. A star schema is characterized by one or more very large fact tables that contain the primary information in the data warehouse and one or more much smaller dimension tables (or lookup tables), each of which contains information about the entries for a particular attribute in the fact table. A star query is a join between a fact table and one or more dimension tables. Each dimension table is joined to the fact table using a primary-key to foreign-key join, but the dimension tables are not joined to each other.

Database systems frequently use a query optimizer to evaluate queries involving joins across multiple tables. The purpose of the query optimizer is to come up with a query plan that evaluates such queries accurately while minimizing the execution cost of the query. Calculating the execution cost of a query often requires the optimizer to estimate the cardinality of multiple two-table joins, involving tables present in the original query. These cardinality estimates are usually approximate, relying on histograms or sampling, as exact estimates would be too expensive.

As a simple example, suppose the database system wants to evaluate the following query:
SELECT*FROM Table1, Table2, Table3 WHERE Table1.Join_Key1=Table2.Join_Key1 AND Table2.Join_Key2=Table3.Join_Key2

In this case, the optimizer may estimate the cardinality of the ‘Table1-Table2’ join, as well as the cardinality of the ‘Table2-Table3’ join before it arrives at a query plan. In addition to join conditions, there might be filter conditions on one or more columns in any of these tables. Then, the cardinality estimates must include filter selectivities in their estimates as well.

The estimation method should meet two conditions to be useful. First, it should be reasonably accurate, as inaccurate estimates lead to less efficient query plans. Second, it should be fast and computationally inexpensive, because the time spent in the plan generation phase of query execution (often called the “compilation time” or “parse time”) should ideally be a small fraction of the actual query execution time. These conditions are in opposition to each other because methods that give more accurate estimates tend to be more expensive. Join cardinality estimation techniques can be divided into two categories: offline approaches and online approaches. While offline approaches are faster and have less computational cost, online approaches tend to be more accurate.

Offline approaches gather statistics about data characteristics in advance before the optimizer has access to the query being evaluated. Once the query is available, these statistics are used to arrive at cardinality estimates. With offline approaches, the query optimizer does not collect specific information tailored to the incoming query during its cardinality estimate phase. In contrast, online approaches can gather additional information once the query to be executed is available, and as a result, the information gathered can be specifically tailored to the query.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating a histogram-augmented dynamic sampling approach in accordance with an illustrative embodiment.

FIG. 2 is a flowchart illustrating operation of a database management system performing weighted histogram construction during statistics gathering in accordance with an illustrative embodiment.

FIG. 3 is a flowchart illustrating operation of database management system performing histogram-augmented dynamic sampling during cardinality estimation in accordance with an illustrative embodiment.

FIG. 4 is a flowchart of a database management system performing a cardinality estimate in cases where no matching keys are found in the key and row histograms after filters are applied in accordance with an illustrative embodiment.

FIG. 5 is a block diagram that illustrates a computer system upon which an embodiment of the invention may be implemented.

FIG. 6 is a block diagram of a basic software system that may be employed for controlling the operation of a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Cardinality estimation of joins between tables plays an important role in cost-based optimizers. Often, an accurate join size estimation requires an expensive join between a sample from the larger table (often a fact table, foreign key table, or child table) and the smaller table (often a dimension table, primary key table, or parent table) during parse time. The illustrative embodiment provides a less expensive approach for join size estimation for two-table (e.g., fact-table-to-dimension-table) joins where the smaller table is joined with a carefully constructed weighted histogram representing the larger table.

The histogram-augmented dynamic sampling (HDS) approach of the illustrative embodiment shares the same basic idea with sampling techniques like end-biased sampling and two-phase sampling. For accurate cardinality estimates, high-frequency or popular key values should be included in the sample while also providing representation to a large number of low frequency or less popular key values. However, the exact sampling design in the illustrative embodiment is different. The HDS approach can be considered a hybrid between online and offline approaches. Unlike offline approaches that rely entirely on histograms in the interest of speed and online approaches that rely entirely on samples to prioritize accuracy, the HDS approach uses a sample of the table on one side of the join for accuracy and relies on a histogram on the other side of the join for speed, with the goal of achieving a balance between the two alternatives.

In one embodiment, the HDS approach uses the entire table on the dimension side of a join for accuracy and relies on a histogram for the fact side for speed. Since the HDS approach uses the entire table on the dimension side, it is able to account for any correlation between join and filter columns on the dimension side. However, the use of histogram for estimates on the fact side of the join means that the HDS approach cannot account for any correlation between fact table filters and the join condition. The tradeoff decision is made based on an empirical observation that dimension-side correlation is much more dominant in its impact on cardinality misestimates than the fact side. In other words, the approach of this embodiment focuses on the more prominent problem. There are real-world performance issues caused by the correlation of dimension table filters. The misestimation of those issues can be corrected by this HDS approach. For fact table filter correlations, we are yet to see a real-world example where they cause join misestimations.

This observation also has support from a theoretical perspective, as the chance of having a dimension table filter correlated to the primary key is 100%, but the chance of having a fact table filter correlated to the foreign key is not 100%. The reason is as follows. A dimension table filter with selectivity less than 1.0 will always remove some keys from the join column (primary key) of the dimension table and alter the original join key distribution. But for fact tables, since the join column (foreign key) is not unique, it is possible to have a fact table filter that does not change the distribution of the join keys significantly or not change the distribution of the join keys at all.

Another reason for using the entire table on the dimension side is that dimension tables are often small enough that using the entire table is not too expensive. In other words, while the key-based approaches described above were mainly designed only with accuracy in mind, the HDS approach strives for a balance between accuracy and other practical concerns in database management systems (DBMSs), including minimizing the storage and maintenance costs of the samples and lowering the query compilation (parse time) costs to a manageable level. The HDS approach also reduces development and support costs and obviates the need to create additional auxiliary structures by leveraging existing statistical infrastructure such as histograms that exist in many databases.

In one embodiment, the HDS approach combines cardinality estimates from a row histogram (which contains a sample of the Fact table's high frequency keys) and a key histogram (which contains a frequency-agnostic random sample of keys) into a single cardinality estimate, along with a confidence interval around the estimate. This requires scaling each histogram key by its probability of inclusion in the sample. This probability is calculated by modeling key selection as a Binomial process.

Previous approaches have either relied on joining table samples to estimate join cardinality or have made independence assumptions to entirely avoid joins between samples during parse time for efficiency. The illustrative embodiments use a hybrid approach, which combines features of both offline and online approaches, thus avoiding joins between two samples and instead joining the smaller table with a key sample from the smaller table with a weighted histogram containing data about the larger table. That is, the illustrative embodiments do a table-to-histogram join, instead of a sample-to-sample join. The approach of the illustrative embodiments then relies on single-table sampling to get selectivity estimates for predicates on the Fact table. This is more efficient than joining two samples, while providing better estimates than approaches that avoid joins entirely by simply using the normal statistics.

Like key-based sampling, the approach of the illustrative embodiments selects keys using a hash function shared across tables. However, instead of maintaining one sample per table, the HDS approach maintains only two histograms that contain selected keys from all relevant tables, along with a weight associated with each key, that depends on its selection probability. As a result, the storage and processing time required is smaller, and maintenance is easier.

The HDS approach addresses the data skew problem by including high frequency keys in the weighted histogram. However, unlike end-biased sampling, the HDS approach does not require a full table scan to identify the high frequency keys, because the high frequency keys are identified from the sample. The approximate nature of the data due to sampling is handled via a statistical model that provides an approximation of the key frequency based on the cardinality observed in the sample. The error in the approximation is calculated via a statistical technique and is used to decide whether the HDS estimate is accurate enough to be used or not.

Since the cardinality estimate is based on a sample, all histogram keys must be weighted to scale the sample-level cardinality estimate to the entire dataset. The weight of each key is the inverse of its probability of inclusion in the sample. To calculate this probability, the illustrative embodiment models the inclusion of each key as a Binomial process. The weight calculated for each key is stored in the histograms as an extra column. The HDS approach uses these weights to calculate a confidence interval around the cardinality estimate. The cardinality estimate is used only if the confidence interval is within acceptable bounds (acceptance criterion). If the cardinality estimate is outside acceptable bounds, the optimizer may fall back on an estimate calculated using traditional techniques (e.g., histograms or dynamic sampling).

Besides join size estimates, the key histogram serves as a dual-purpose tool for the optimizer. This is because the histogram maintains a random frequency-agnostic set of keys selected from the table. This sample is useful for estimating the number of distinct values, a statistic frequently used by the optimizer for cardinality estimates.

Thus, the HDS approach of the illustrative embodiments enables the optimizer to arrive at more accurate join size estimates without spending unacceptably long time in the query compilation/planning phase. More accurate join size estimates result in better query plans, giving better DBMS performance.

### Offline Approaches

Offline approaches rely on pre-computed data structures, which are used at the time of query execution to identify a query plan. Histograms are the most commonly used data structure. Usually, a histogram is constructed for each table column, and join and filter column histograms are respectively used to estimate join key frequency and filter selectivity. While histograms are easy to create and maintain, they contain limited information about the data distribution. For example, the hybrid histogram, a commonly used histogram in database optimizers, is built over a sample of rows (e.g., 5500 rows) and stores information only about keys found in this random sample.

Histograms also usually do not contain information about the degree of correlation between filter and join columns. The term “correlation” is used to refer to the degree to which the filters change the distribution of the join keys. As an example, consider a table with 100 rows, where the join column has 10 rows with value ‘A’, 20 rows with value ‘B’, and 70 rows with value ‘C’. Suppose after the query filters are applied, the filtered table has 50 rows. Then we say that there is filter-join correlation as long as the join column in the filtered table is not distributed as 5 (10%) with value ‘A’, 10 (20%) rows with value ‘B’, and 35 (70%) rows with value ‘C’.

Single-column histograms can provide approximate information about what fraction of rows are being removed by a query's filter clause (the filter selectivity). Because they maintain information for each column individually, single-column histograms do not contain information about across-column correlations and cannot inform the optimizer about what exact set of join keys are being removed by a filter. However, there are many situations where information about the exact set of join keys being removed is essential for accurate estimates. For example, the dataset may be skewed such that the fact table contains a few high frequency join keys. Therefore, for accurate cardinality estimates, it is important to know whether these join keys are filtered out on the dimension side. While multiple-column histograms can be constructed to address this problem, they are not commonly used as they are expensive and provide only limited information.

### Online (Sampling-Based) Approaches

Online approaches do not rely on pre-computed statistics for cardinality estimates. Instead, they try to estimate the relevant statistics once the query becomes available. This is usually more accurate as the exact query join and filter conditions are available. The usual method to do this is via sampling. The common sampling techniques can be divided into two categories: random (row-based) sampling and key-based sampling.

### Random (Row-Based) Sampling

Single-table cardinality can be estimated quite accurately by selecting a uniformly random sample of rows from a table and applying any relevant filters. Filter selectivity on the sample can then be used to infer filter selectivity on the entire dataset.

For join cardinality estimates, dynamic sampling arrives at estimates by joining a random sample from the larger table with the entirety of the smaller table. However, since a random sample of rows is often too expensive to collect, the optimizer relies on a random sample of data blocks, where all the rows in randomly selected data blocks are included in the sample.

As block samples tend to provide less accurate cardinality estimates (compared to row samples) due to within-block correlation of rows, the optimizer uses a progressive sampling technique. Progressive sampling goes through multiple rounds of taking a block sample from the relevant table and checking after each round if the aggregated sample meets certain statistical criteria of sample quality. Sampling stops only when these statistical criteria are satisfied. While block sampling is relatively cheap and highly effective for single-table cardinality estimates, it can be prohibitively expensive for join size estimates.

### Key-Based Sampling

Key-based sampling methods provide an alternative sampling approach, where samples are materialized from each table in the workload in advance. Given a query, the query filters for a particular table can then be directly applied on the sample. The observed filter selectivity on the sample gives an estimate of the filters' selectivity on the original table. Note that while the samples are materialized in advance, the query filters and joins are applied on the sample only once the query has been seen. As a result, key-based sampling approaches are better categorized as online approaches.

The goal of key-based sampling is to guarantee that when two table samples are joined on a key, the result has enough rows to make accurate cardinality estimates possible. This overcomes the drawback of uniform random (row) samples: if row samples taken from two tables are joined, the probability that rows with the same join key are selected in both samples is too low, making row samples useless for join size estimation. In contrast, the goal of key-based sampling is to create pre-computed samples that share the same set of join keys without performing an actual join (a condition essential for efficiency/performance during pre-processing). This is usually achieved by using a shared hash function on the join column in each table. This of course assumes that the join column names for a workload are known in advance. The most straightforward key-based sampling approach is correlated sampling, which is described next.

Say one wants to estimate the cardinality of the join F_{J} [symbol] D_{K} on two tables F and D, where column J from table F joins with column K from table D. Then the correlated sample is created by applying a hash function h:x→y, y∈ [symbol] , 0≤y≤1 on columns F.J and D.K (in other words, h(x) is a function that takes a string as input and deterministically returns a value between 0 and 1 as output). All rows from table F for which h(F.J)≤t are included in its pre-computed sample, where t is a pre-set threshold. Similarly for D, all rows are included in its sample for which h(D.K)≤t. In this way, it can be guaranteed that the respective samples from F and J share the same set of keys in their join column, without physically sharing any data between the two tables or performing an actual join.

A drawback of correlated sampling is vulnerability to data skew. Since all join keys are equally likely to be included in the sample, irrespective of their frequency in the table, high frequency (a.k.a. popular) keys can be absent in the sample, leading to inaccurate estimates for skewed tables. This drawback is addressed by approaches such as end-biased sampling by doing an initial scan of each table to identify high-frequency keys. Keys above a pre-set frequency are then always included in the final sample irrespective of whether the output of the hash function on the keys is below the threshold t.

Another drawback of correlated sampling is its inflexibility, because of which an inefficient sample might be selected that has a large number of rows but still has a high error margin around cardinality estimates. For example, in correlated sampling (and also in end-biased sampling), for highly skewed data, if a high cardinality key is selected into the sample, all the rows with that key are required to be part of the sample. Two-level sampling addresses this by using a two-level sampling process.

The first level of two-level sampling is a key-level sampling process where a subset of join keys is selected to be included in the sample. There are two methods for key selection: a) a frequency-aware version where each key v is selected into the sample with a probability p(v), which depends on the frequency of v, and b) a frequency-unaware version where all keys have the same probability p of selection. Following this first step, for each key selected into the sample, a single “sentry” row is selected, which is guaranteed to be part of the final sample, while other rows with the key are tentatively included as candidates for the second level of sampling. In the second level of sampling, each candidate row is included in the final sample with a constant probability q. The key advantage of two-level sampling is that the values p and q can be set, depending on the data distribution, to minimize error bounds for a given sample size.

Key-based sampling approaches have the drawback that the samples are usually large in size (as they include all columns in the table). Even for methods such as two-level sampling, which try to minimize the number of rows in the sample, the final sample is usually large because all columns need to be stored as part of the final sample. Samples are also expensive to maintain over time, because a change in any column of a row in the original table must be reflected in the histogram (if the row is included in the sample). For this reason, database systems usually rely on frequency histograms instead of key-based samples, which are much cheaper to maintain.

### Histogram-Augmented Dynamic Sampling Approach

The histogram-augmented dynamic sampling (HDS) approach of the illustrative embodiment is applicable to database instances consisting of fact and dimension tables following the star schema model. The approach assumes the following information is available as input:
1. Two mutually exclusive lists, specifying which tables are considered fact tables and which tables are considered dimension tables.
2. For each of these fact tables, a list of dimension tables that join with the table and a set of join conditions J, describing which column of the fact table joins with which column of each dimension table.

In general, fact tables are expected to be much larger than dimension tables. The HDS approach builds histograms offline on the fact tables (thus saving on cost by not scanning these large tables during query compilation). These histograms are then joined with dimension tables in their entirety for cardinality estimation.

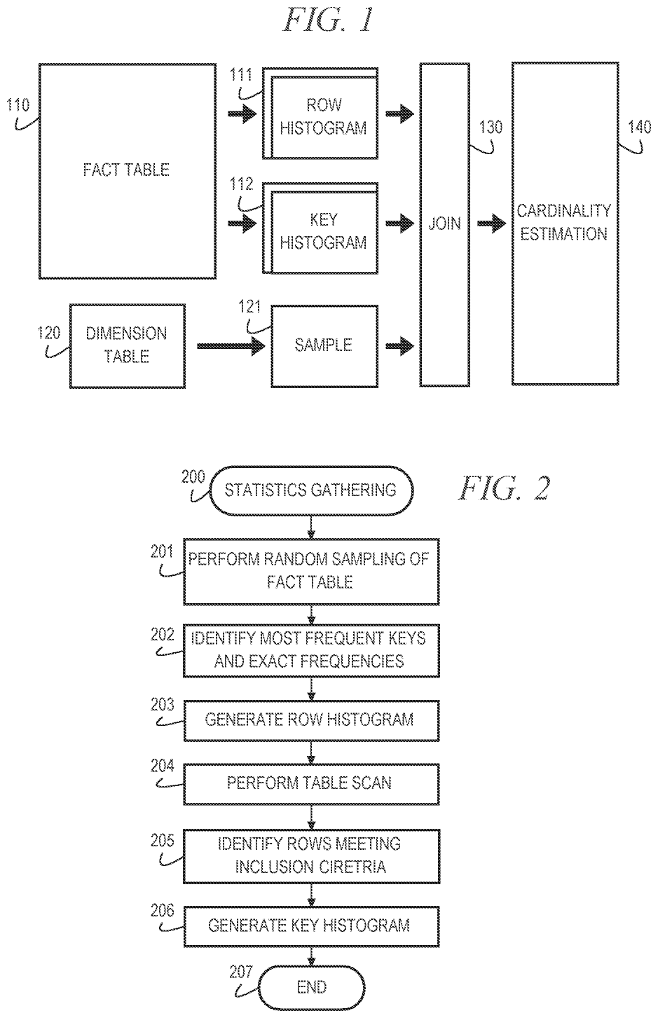

FIG. 1 is a block diagram illustrating a histogram-augmented dynamic sampling approach in accordance with an illustrative embodiment. The HDS approach of the illustrative embodiment has two phases:
1. Preprocessing Phase (offline): In the pre-processing phase, data structures are created that will be used during the query compilation phase for cardinality estimation. These data structures are row histogram 111 and row histograms 112, that are created for selected columns of fact table 110.
2. Cardinality Estimation Phase (online): The cardinality estimation phase is when the HDS data structures, row histogram 111 and key histogram 112, are used to estimate the cardinality of various joins, and this happens at the time of query compilation. In this phase, the system executes queries that join 130 the histograms with a sample 121 of each relevant dimension table 120, to perform cardinality estimation 140.

These two phases are described in further detail below.

### 1. Weighted Histogram Construction During Statistics Gathering

The HDS approach relies on two kinds of histograms: row histograms and key histograms. The goal of the row histogram is to ensure that high frequency (or popular) keys are part of the estimation process, to address the data skew problem discussed earlier. The goal of the key histogram is to ensure representation for a large number of distinct keys that individually have low frequency. Since the row histogram is built so as to be dominated by high frequency keys, the key histogram assures that queries involving low frequency keys can also be estimated satisfactorily.

There are two kinds of supported row histograms: the top-N frequency histogram and the hybrid histogram. A top-N frequency histogram is gathered through lossy counting sketch (LCS) algorithm and identifies the top N most frequent keys, along with their exact frequency in the table.

Hybrid histograms are histograms built on a random sample of rows from the table. Because hybrid histograms are built using a random sample, they are highly likely to include high-frequency keys for each column they are built on. Hybrid histograms are built by taking a uniform random sample of a predetermined number of rows (e.g., 5500 rows). However, in accordance with some embodiments, not all the sample's keys are used, because a lot of the keys in this sample may not be high-frequency (or popular) keys. Instead, the approach of these embodiments creates a separate row histogram table for HDS, which only stores identified popular keys in the sample. Popular keys are defined as keys observed at least twenty times in the random sample. This definition is used as it has been traditionally used as a definition of popularity. It originates in the hybrid histogram construction process where keys with frequency greater than a predetermined threshold (e.g., nineteen) are highly likely to be a histogram bucket endpoint.

The HDS approach of the illustrative embodiment has some subtle differences depending on the type of row histogram. These differences are discussed below.

Like row histograms, key histograms are constructed on columns, but they are only constructed for join key columns. As mentioned earlier, this information about join key columns is assumed to be available. Key histograms are histograms that maintain for certain randomly chosen join keys the number of rows in the fact table that have that key in the join column. Unlike row histograms, which are more likely to include high-frequency keys, all keys, irrespective of frequency, are equally likely to be present in the key histogram.

Key histograms are built by scanning the table once and applying a hash function to the join key in each row that maps the key to a uniform random value between 0 and 1. Then all keys in the table whose join key hash value is below a certain selectivity threshold t (0<t<1) are included in the key histogram. Following this, any popular value in the row histogram that is also included in the key histogram is removed from the key histogram.

In some embodiments, the HDS approach does not maintain a key (or row) histogram per key column. Instead, the key histograms are all maintained within a single table (called Key_Histogram_Table) with the following columns: (Table_Name, Column_Name, Key_Hash_Value, Key_Frequency, Weight). Because all table columns are stored within the same table, the first two columns (Table_Name and Column_Name) identify which table column the key is sampled from. The column Key_Hash_Value stores the key in hashed form. The next column, Key_Frequency, stores the frequency of the key value in the table. The next column stores a weight for each key, which is calculated as described below.

The row histograms are maintained similarly in a table (called Row_Histogram_Table), with the same set of columns as the key histogram. However, for the row histograms, the value in the Key_Frequency column depends on the type of row histogram. For top-N histograms, this column stores the frequency of the key in the entire table. For hybrid histograms, this column stores the observed frequency of the key in the random sample (not the entire table).

FIG. 2 is a flowchart illustrating operation of a database management system performing weighted histogram construction during statistics gathering in accordance with an illustrative embodiment. Operation begins during statistics gathering (block 200), and the system performs random sampling of the fact table (block 201). The system then identifies the most frequent keys and exact frequencies (block 202) and generates a row histogram (block 203). The system then performs a table scan (block 204), identifies rows meeting the inclusion criteria (block 205), and generates a key histogram (block 206). Thereafter, operation ends (block 207).

### 2. HDS During Cardinality Estimation

The HDS approach estimates the join cardinality of the unfiltered fact table joining with the dimension table, with dimension table filters included. The HDS approach does not address the fact-side table filters as part of its core model. How the HDS approach addresses this is discussed below.

The HDS approach proceeds by joining the dimension table with the key histogram, as well as the row histogram. The cardinality of these two join results is weighed appropriately and added together, to give the query cardinality estimate.

As a detailed example, assume that the optimizer, as part of its compilation process, wants to estimate the cardinality of the following query:
SELECT COUNT(*) FROM Fact_Table F, Dimension Table D WHERE F.col1=D.col1 AND F.col2=‘x’ and D.col3=‘y’;

Then, the HDS approach runs two queries, where one joins Dimension_Table with the key histogram for column coil of Fact_Table and the other joins Dimension_Table with the row histogram for column coil of Fact_Table.

The key histogram query takes the following form:
SELECT SUM(K.Key_Frequency/Weight) FROM Dimension_Table D, Key_Histogram K WHERE K.Table_Name=‘Fact Table’ AND K.Column_Name=‘coil’ and K.Key_Hash_Value=hash(D.col1) and D.col3=‘y’;

Similarly, the row histogram query takes the following form:
SELECT SUM(R.Key Frequency/Weight) FROM Dimension Table D, Row Histogram R WHERE R.Table_Name=‘Fact Table’ and R.Column_Name=‘col1’ and R.Key_Hash_Value=hash(D.col1) and D.col3=‘y’;

The results of these two queries are added to give the query cardinality estimate. The execution of these queries is speeded up considerably by sorting the Key_Histogram and Row_Histogram tables by (Table_Name, Column_Name), and building an index on these two columns.

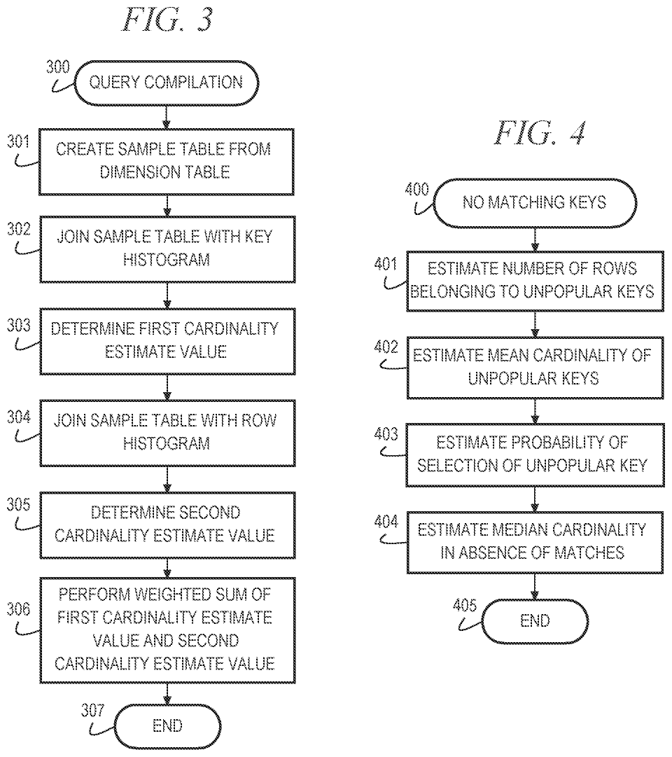

FIG. 3 is a flowchart illustrating operation of database management system performing histogram-augmented dynamic sampling during cardinality estimation in accordance with an illustrative embodiment. Operation begins during query compilation for a query involving a two-table join of a fact table with a dimension table (block 300). The system creates a sample table from the dimension table (block 301). In some embodiments, the sample is the entire dimension table. The system joins the sample table with the key histogram (block 302) and determines a first cardinality estimate value (block 303). The system also joins the sample table with the row histogram (block 304) and determines a second cardinality estimate value (block 305). Then, the system performs a weighted sum of the first cardinality estimate value and the second cardinality estimate value to determine the cardinality estimate for the two-table join (block 306). Thereafter, operation ends (block 307).

Mathematically, the cardinality estimation process can be represented using the formula below, where the first term represents the result of the first query, while the second term represents the result of the second query:

$${J}_{HDS} = {\sum }_{k ∈ {S}_{k}} \frac{J ( k )}{{p}_{k}} + {\sum }_{r ∈ {S}_{pop}} \frac{J ( r )}{{p}_{r}}$$

The notation for the above equation and equations that follow is as follows: D is the number of distinct values of the fact table column on which augmented histograms are to be gathered; Sₖ is the set of keys in the key histogram after popular values have been removed; Sₚₒₚ is the set of high frequency (or popular) keys in the row histogram; c is the cardinality of the table; cₕᵢₛₜ is the sample size used to construct the row histogram (a traditional value for cₕᵢₛₜ is 5500) (this value is only applicable to row histograms and is not relevant if an LCS histogram is used); τ is the threshold above which keys in the row histogram are considered popular (e.g., τ=19 as a default value); cₕᵢₛₜⁱ is the cardinality in a row histogram for any key in the row histogram (keys with frequency greater than a threshold τ in the row histogram are considered popular keys); pₖ is the inclusion probability of a key in the key histogram (same for all keys); pᵣ is the inclusion probability of a key in the row histogram (same for all keys) (this value is 1 for LCS row histograms but depends on the sample size used for histogram construction in traditional row-sampling histograms); hᵢ is the frequency of key I in the histogram for traditional row histograms, i∈Sₚₒₚ; fᵢ is the frequency of the key I in the fact table (fᵢ is exact if i is from key histograms or LCS row histograms) (for traditional row histograms, it is approximated as hᵢ/pᵣ; J(k) is the join cardinality produced by the key k∈Sₖ joining the dimension table (due to the property of PK-PK joins, J(k) is either 0 or fᵢ; J(r) is the join cardinality produced by the key r∈Sₚₒₚ joining the dimension table (J(r) is either 0 or fᵢ for LCS histograms and either 0 or hi for row sampling histograms; and, J_{HDS} is the join cardinality accounting for the join condition and the dimension filters.

The first term in the above equation is derived from the join between the key histogram and the dimension table. The term J(k) represents, for each key in the key histogram, the cardinality resulting from joining it with the dimension table. For keys that occur exactly once in the dimension table, this value is equal to the value in the Key_Frequency column in the key histogram. For keys that occur more than once in the dimension table, this value is the product of the key's occurrence frequency in the dimension table, and the Key_Frequency column in the key histogram. This summation term J(k) for each key is scaled by a weight 1/pₖ (stored in the Weight column in Key_Histogram_Table), where pₖ is the key inclusion probability. The process for calculating these weights is discussed below.

Similarly, the second term in the above equation is derived from the join between the row histogram and the dimension table. The term J(r) (for each popular key derived from the row histogram), like the term J(k) in the first expression, represents the cardinality resulting from joining the key with the dimension table. Each key is scaled by a weight 1/pᵣ (stored in the Weight column in Row_Histogram_Table), where pᵣ is the inclusion probability into the row histogram (discussed further below).

### Setting Key Weights

The inclusion probabilities pₖ and pᵣ are set as follows for the top N (or LCS [7]) histograms:

$${p}_{k} = \frac{\vert {S}_{k} \vert}{D - \vert {S}_{pop} \vert} \\ {p}_{r} = 1$$

Here, D is the total number of distinct values in the fact table, |Sₚₒₚ| is the number of high frequency/popular keys in the row histogram, and |Sₖ| is the number of distinct keys in the key histogram.

The inclusion probability p_{K} is set as follows for row sampling histograms:

$${p}_{K} = [ {( 1 - \frac{{c}_{hist}}{c} )}^{{f}_{k}} ] \cdot \frac{\vert {S}_{k} \vert}{D - \vert {S}_{pop} \vert}$$

The calculation of the inclusion probability pᵣ for row sampling histograms is more complex. It is calculated by modeling the row histogram key selected as a Binomial distribution. The Bernoulli probability of selecting a row with a given key i is given by:

$${q}_{i} = \frac{{c}_{hist}^{i}}{{c}_{hist}}$$

Here, cₕᵢₛₜⁱ is the cardinality of the key in the row histogram, and cₕᵢₛₜ is the table size. Then, the inclusion probability of the key in the row histogram is one minus the probability that the key is included τ or fewer times in the row histogram, calculated as follows:

$${p}_{i} = 1 - {\sum }_{m = 0}^{τ} \frac{τ !}{m ! ( τ - m ) !} {q}_{i}^{m} \cdot {( 1 - {q}_{i} )}^{τ - m}$$

This formula is expensive to calculate, but fortunately the inclusion probabilities for most values of cₕᵢₛₜⁱ can be calculated in advance and stored in a table. Table 1 below shows pᵢ values for different values of cₕᵢₛₜⁱ.

TABLE 1

| Observed Cardinality in | Inclusion |
|---|---|
| Row Histogram | Probability (pᵢ) |
| 20 | 0.53 |
| 21 | 0.62 |
| 22 | 0.69 |
| 23 | 0.76 |
| 24 | 0.82 |
| 25 | 0.87 |
| 26 | 0.90 |
| 27 | 0.93 |
| 28 | 0.95 |
| 29 | 0.97 |
| ≥30 | 1 |

### Fact-Side Query Filters

As mentioned above, because the HDS approach uses a histogram to estimate the cardinality of the fact side of the join query, it does not have a direct way to estimate the selectivity of the fact side filters. To address this, the HDS approach relies on the optimizer to estimate the fact-side filter selectivity. The fact side filter selectivity is multiplied by the HDS join estimate to arrive at the final cardinality estimate of the fact table and dimension table join.

### Quality Metrics

Because the HDS approach is essentially a sample estimate, a quality metric may be used to determine whether the estimate is associated with sufficient confidence. The estimate is not reliable if its variance is too large. The variance of J_{HDS} is estimated as follows:

$$\hat{V} [ {J}_{HDS} ] = {\sum }_{k ∈ {S}_{k}} {[ J ( k ) ]}^{2} ( \frac{1}{{p}_{k}} - 1 ) + {\sum }_{r ∈ {S}_{pop}} {[ J ( r ) ]}^{2} ( \frac{1}{{p}_{r}} - 1 )$$

Because the inclusion probability pᵣ=1 for top-N(or LCS) histograms, the row histogram variance (second) term of the above equation is 0. This is because the LCS histogram algorithm is deterministic, so its contribution to the variance is 0. The join cardinality estimate J_{HDS} follows a Normal distribution, so a 95% confidence interval on the estimate is provided by:

$${J}_{HDS} \pm 1.64 \sqrt{\hat{V} [ {J}_{HDS} ]}$$

Any confidence interval within [0.5x, 2x] of the ground truth is considered acceptable. If the quality check passes, the estimate J_{HDS} is accepted; otherwise, the system falls back to another code path (using progressive sampling).

### Estimate for Zero Matches in Histogram

FIG. 4 is a flowchart of a database management system performing a cardinality estimate in cases where no matching keys are found in the key and row histograms after filters are applied in accordance with an illustrative embodiment. Operation begins when no matching keys are found in the key and row histograms after filters are applied (block 400). The system estimates the number of rows belonging to unpopular keys (block 401) as follows:

$${c}^{′} = c - {\sum }_{r ∈ {S}_{pop}} {f}_{r}$$

The system then estimates the mean cardinality of unpopular keys (block 402) as follows:

$${ρ}^{′} = \frac{{c}^{′}}{D - \vert {S}_{pop} \vert}$$

The system then estimates the probability of an unpopular key (block 403) as follows:

$${p}_{k}^{′} = \frac{\vert {S}_{k} \vert}{D - \vert {S}_{pop} \vert}$$

The system estimates the mean cardinality in the absence of matches (block 404) as follows:

$${J}^{′} = \frac{log ( 0.5 )}{log ( 1 - {p}_{k}^{′} )} {ρ}^{′}$$

Thereafter, operation ends (block 405).

### Quality Metric for Zero Matches in Histogram

The 95^{th} percentile upper bound in the case where 0 matches are found in the key and row histograms is given as follows:

$${J}_{95}^{′} = \frac{log ( 0.05 )}{log ( 1 - {p}_{k}^{′} )} {ρ}^{′}$$

Taking the ratio of the 95^{th} percentile cardinality estimate to the median estimate (J_{median}′), it can be seen that the confidence interval width is always fixed at:

$$\frac{{J}_{95}^{′}}{{J}_{median}^{′}} = \frac{log ( 0.05 )}{log ( 0.5 )} = 4.3$$

In other words, in cases where no matches are found in the row and key histograms, the 95^{th} percentile upper bound is always 4.3 times the median. This is more than twice the usual quality metric: that the upper bound be within 2× of the estimate. However, in absolute terms, the confidence interval width might be quite small. This is because if no matches are found in either histogram, the query is likely to be a low cardinality query, and the median estimate will adequately reflect that.

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MongoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

A database object may have an attribute that is a primary key. A primary key contains primary key values. A primary key value uniquely identifies a record among the records in the database object. For example, a database table may include a column that is a primary key. Each row in the database table holds a primary key value that uniquely identifies the row among the rows in the database table.

A database object may have an attribute that is a foreign key of a primary key of another database object. A foreign key of a primary key contains primary key values of the primary key. Thus, a foreign key value in the foreign key uniquely identifies a record in the respective database object of the primary key.

A foreign key constraint based on a primary key may be defined for a foreign key. A DBMS ensures that any value in the foreign key exists in the primary key. A foreign key need not be defined for a foreign key. Instead, a foreign key relationship may be defined for the foreign key. Applications that populate the foreign key are configured to ensure that foreign key values in the foreign key exist in the respective primary. An application may maintain a foreign key in this way even when no foreign relationship is defined for the foreign key.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

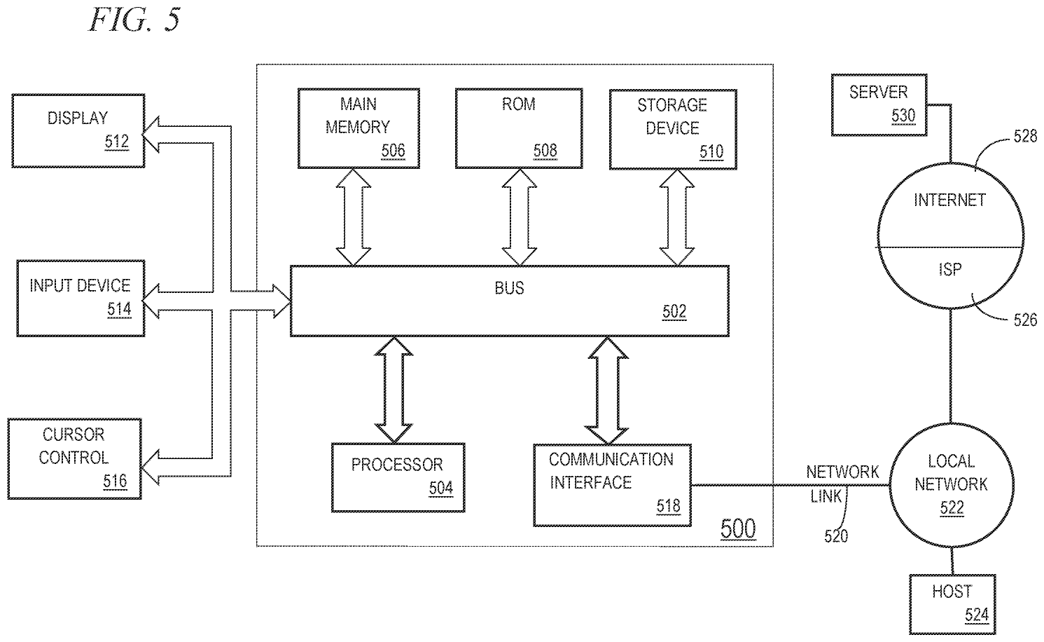

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

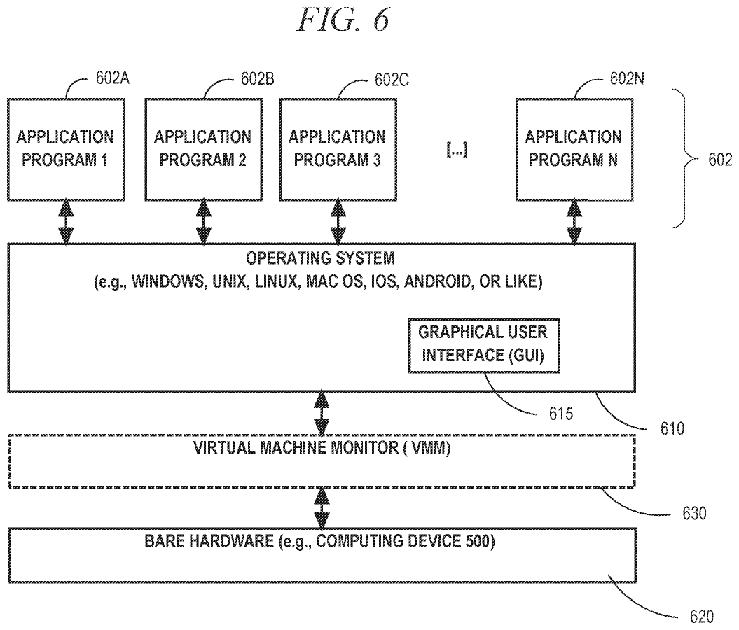

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device 1/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 500 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
for a query involving a join of a first table and a second table based on a join key, performing cardinality estimation for the join, wherein performing cardinality estimation comprises determining an estimated cardinality value for the join based on a join of a histogram table, based on the first table, and a sample table, based on the second table;
performing a query optimization operation for the query based on the estimated cardinality value; and
executing the query based on the query optimization operation,
wherein the method is performed by one or more computing devices.

2. The method of claim 1, wherein:
the first table is a fact table, and
the second table is a dimension table.

3. The method of claim 1, wherein the join key is a foreign key of the first table and a primary key of the second table.

4. The method of claim 1, wherein performing cardinality estimation comprises:
determining a first cardinality value based on a join of a row histogram table, based on the first table, and the sample table;
determining a second cardinality value based on a join of a key histogram table, based on the first table, and the sample table; and
performing a sum of the first cardinality value and the second cardinality value to form the estimated cardinality value.

5. The method of claim 4, wherein the row histogram table and the key histogram table are generated during a statistics gathering phase prior to receiving the query.

6. The method of claim 4, wherein the row histogram table identifies a predetermined number of most frequent keys and their exact frequencies in the first table.

7. The method of claim 4, wherein the key histogram table is generated using a predetermined number of randomly selected rows of the first table and corresponding sampled frequencies in the first table.

8. The method of claim 4, wherein the key histogram table is generated by performing a table scan of the first table, applying a hash function to a given column in each row to generate a hash value, and including rows having a hash value that meets an inclusion criterion.

9. The method of claim 4, wherein the sum is a weighted sum.

10. The method of claim 4, further comprising:
in response to determining no matching keys are found in the key histogram table and the row histogram table after filters are applied:
estimating a number of rows belonging to unpopular keys;
estimating a mean cardinality of unpopular keys based on the estimated number of rows belonging to unpopular keys;
estimating a probability of selection of a particular unpopular key; and
estimating a mean cardinality in the absence of matches based on the estimated mean cardinality of unpopular keys and the estimated probability of selection of the particular unpopular key.

11. The method of claim 1, wherein:
the query involves a filter condition on the second table, and
performing cardinality estimation comprises applying the filter condition to the join of the histogram table and the sample table.

12. The method of claim 1, wherein:
the query involves a filter condition on the first table,
performing cardinality estimation comprises estimating filter selectivity of the first table based on the filter condition and multiplying the estimated filter selectivity of the first table by the estimated cardinality value.

13. The method of claim 1, further comprising:
determining a quality metric for the cardinality estimation; and
performing the query optimization operation for the query based on the estimated cardinality value in response to the quality metric satisfying a quality metric acceptance criterion.

14. One or more non-transitory storage media storing instructions which, when executed by one or more computing devices, cause performance of a method comprising:
for a query involving a join of a first table and a second table based on a join key, performing cardinality estimation for the join, wherein performing cardinality estimation comprises determining an estimated cardinality value for the join based on a join of a histogram table, based on the first table, and a sample table, based on the second table;
performing a query optimization operation for the query based on the estimated cardinality value; and
executing the query based the query optimization operation.

15. The one or more non-transitory storage media of claim 14, wherein:
the first table is a fact table, and
the second table is a dimension table.

16. The one or more non-transitory storage media of claim 14, wherein performing cardinality estimation comprises:
determining a first cardinality value based on a join of a row histogram table, based on the first table, and the sample table;
determining a second cardinality value based on a join of a key histogram table, based on the first table, and the sample table; and
performing a sum of the first cardinality value and the second cardinality value to form the estimated cardinality value.

17. The one or more non-transitory storage media of claim 16, wherein the row histogram table and the key histogram table are generated during a statistics gathering phase prior to receiving the query.

18. The one or more non-transitory storage media of claim 16, wherein the key histogram table is generated by performing a table scan of the first table, applying a hash function to a given column in each row to generate a hash value, and including rows having a hash value that meets an inclusion criterion.

19. The one or more non-transitory storage media of claim 14, wherein:
the query involves a filter condition on the second table, and
performing cardinality estimation comprises applying the filter condition to the join of the histogram table and the sample table.

20. The one or more non-transitory storage media of claim 14, wherein:
the query involves a filter condition on the first table, and
performing cardinality estimation comprises estimating filter selectivity of the first table based on the filter condition and multiplying the estimated filter selectivity of the first table by the estimated cardinality value.
